(19) United States
(12) Patent Application Publication
(10) Pub. No.: US 2008/0006960 A1
(43) Pub. Date: Jan. 10, 2008

(54) Melamine utensil and manufacturing method thereof

(75) Inventor: Kwo-Chin Chen, Pan Chiao City (TW)

Correspondence Address: TROXELL LAW OFFICE PLLC;SUITE 1404, 5205 LEESBURG PIKE, FALLS CHURCH, VA, 22041, US

(73) Assignee: Sara Rose International Inc.

(21) Appl. No.: 11/480,964

(22) Filed: Jul. 6, 2006

(51) Int. Cl. B27N 3/00; C08G 12/30; C08J 5/00

(52) U.S. Cl. 264/109; 528/254; 264/331.12

(57) ABSTRACT

A melamine utensil and a manufacturing method thereof are disclosed. Melamine powder/granule is mixed with a granular/fragmentary secondary material of melamine that has been hot-pressed in a certain weight ratio to form a composite material. Then through a process of hot pressing, shapes and colors of the granular/fragmentary secondary material of melamine are shown on appearance of the utensil clearly so as to increase decorative effect and added value of the melamine utensils.

### BACKGROUND OF THE INVENTION

The present invention relates to a melamine utensil and a manufacturing method thereof, especially to a melamine utensil with secondary material made from mixture of melamine powder/particles and hot-pressed granular/fragmentary secondary material of melamine being treated with a hot pressing process.

The melamine has advantages of easy dyeing, good thermal stability, incombustibility and shone with gleam and thus has been broadly applied to manufacturing of various containers or utensils such as vessels, cups, dishes, bowls, pots and barrels. Conventional manufacturing method of melamine includes following steps:

Put certain amount of single-color or multiple-color melamine powder/granule material into a container. Then set the container with the melamine material into a heater for preheating the material under about 40 Celsius degrees so as to melt the raw material into a soft green compact. Next put the soft green compact into a mold at the temperature of about 180 Celsius degrees for hot pressing. Then release the shaped (formed) melamine utensil from the mold, through cooling and trimming to form a finished melamine utensil. Now a layer of paper with various marks, colors, or figures thereof is covered on the formed melamine utensils by hot pressing. However, the base color of the melamine utensil is the same with that of the melamine powder/granule. Once there are at least two colors of melamine powder/granule mixed together, the material is melt and diffused with each other. The different colors can't be distinguished with one another. Moreover, the attached decorative paper with figures shows quality different from the melamine utensil. The conventional single-colored melamine utensils or utensils with decorative paper is monotonous. And such kind of cheap, mass-produced utensils can't satisfy users requirements any more. Furthermore, the applications and development of melamine utensils are restricted.

### SUMMARY OF THE INVENTION

Therefore it is a primary object of the present invention to provide a melamine utensil and a manufacturing method thereof which use melamine powder/particles and granular secondary material of hot-pressed melamine to form a composite material. Then the composite material is through a hot pressing process so as to make shapes and colors of the granular secondary material of melamine show on surface of finished utensils. Thus the decorative effect as well as added value of the melamine utensils is increased.

It is another object of the present invention to provide a melamine utensil and a manufacturing method thereof that mix melamine powder/particles with fragmentary secondary material of hot-pressed melamine to form a composite material. Then the composite material is through a hot pressing process so as to make shapes and colors of the fragmentary secondary material of melamine show on surface of finished utensils. Thus the decorative effect as well as added value of the melamine utensils is increased.

It is a further object of the present invention to provide a melamine utensil and a manufacturing method thereof that mix melamine powder/particles with granular/fragmentary secondary material of hot-pressed melamine in a certain weight ratio to form a composite material. For example, the melamine powder/particles occupies from 40 to 80 percent while the granular/fragmentary secondary material occupies from 20 to 60 percent by weight. During the hot pressing process, the melamine powder/particles connects with each other and combines firmly among molecules of the granular/fragmentary secondary material of melamine so as to enhance strength and robustness of the finished utensil.

### BRIEF DESCRIPTION OF THE DRAWINGS

FIG. 1 is a perspective view of an embodiment in accordance with the present invention;

FIG. 2 is a front view of the embodiment in FIG. 1;

FIG. 3 is cross sectional view of the embodiment in FIG. 1;

FIG. 4 is a partial enlarged view of the embodiment in FIG. 3;

FIG. 5 is a schematic drawing showing manufacturing process of the present invention;

FIG. 6 is a perspective view of another embodiment in accordance with the present invention;

FIG. 7 is a front view of the embodiment in FIG. 6;

FIG. 8 is cross sectional view of the embodiment in FIG. 6;

FIG. 9 is a partial enlarged view of the embodiment in FIG. 8.

### DETAILED DESCRIPTION OF THE PREFERRED EMBODIMENT

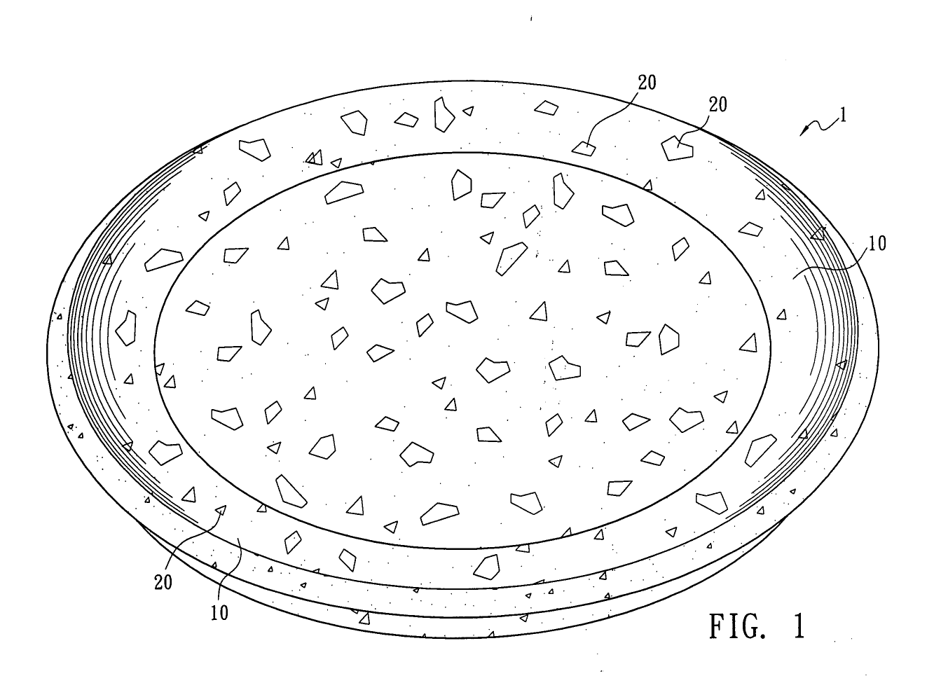

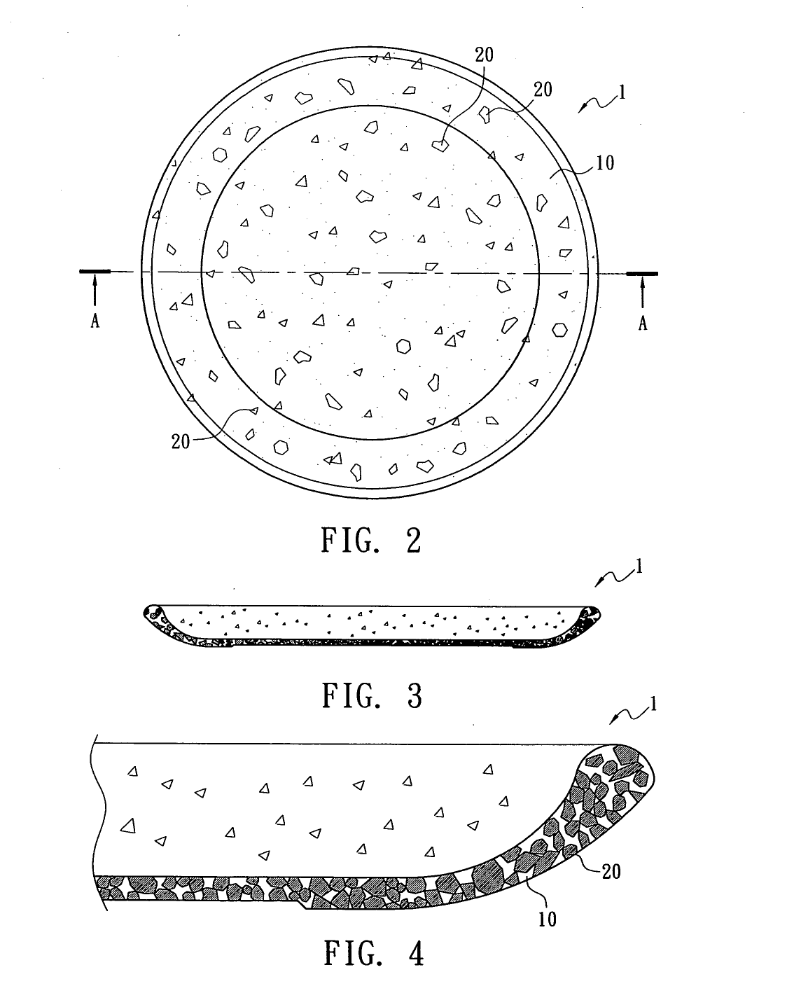

Refer from FIG. 1 to FIG. 5, there is no limit on the shape of the melamine utensils. The melamine utensil includes a primary material 10 formed by melamine powder/particles 10a through hot pressing and a secondary material 20 having hot-pressed melamine granules. Hot-pressed melamine molding compounds with different colors are shredded into granules with different sizes and colors and are mixed again to form granular secondary material 20. Melamine is a kind of thermosetting plastic. The granular secondary material 20 of melamine is called secondary material because the melamine has already been hot-pressed once, and then selected as material for hot-pressing process a second time. When the secondary material 20 is mixed with the melamine powder/particles 10a and then is hot-pressed for a second time, the granular secondary material 20 is no more melt. Thus the granular secondary material 20 with different shapes and colors show clearly on appearance of the melamine utensil 1 when the melamine powder/particles 10a is heated and hot-pressed into the primary material 10, as shown from FIG. 1 to FIG. 4. Traditional melamine utensils and the manufacturing method thereof can't achieve such kind of decorative effects.

During the hot pressing process, the granular secondary material 20 with different sizes and colors flows freely along with a pre-heated green compact 60 inside a mold 70 by hot pressing of male and female molds. When thickness of part of the granular secondary material 20 is larger than that of the finished melamine utensil 1, the granular secondary material 20 may bed down inside the utensil due to pressing of the mold and free flowing, as shown in FIG. 4. Thus the irregular shapes or different colors are shown on one or two surfaces (top and bottom) of the melamine utensil 1. Or the granular secondary material 20 may be pressed into smaller articles by the mold 70. Generally, the thickness of the melamine utensil 1 falls into a certain range. The size as well as the shredding process of the granular secondary material 20 can be controlled. The granules of the granular secondary material 20 can be uniform or with different sizes mixed in a certain ratio. The ratio of the mixture can be adjusted. For example, the thickness of the granules is smaller, close to, or a bit larger than that of the utensil. Or the granules can be a mixture with two different sizes.

The melamine powder/particles 10a and the granular secondary material 20 of the finished melamine is mixed in a certain weight ratio. For example, the melamine powder/particles 10a occupies from 40 to 80 percent while the granular secondary material 20 occupies from 20 to 60 percent by weight of the utensil 1. During the hot pressing process, while forming the primary material 1, the melt melamine powder/particles 10a binds with each other tightly and attaches firmly to molecules of the granular secondary material 20 so as to enhance strength and robustness of the finished melamine utensil 1. Further the shortcoming of easy peeling or crack caused by poor connectivity between the molecules of the granular secondary material 20 of melamine is prevented.

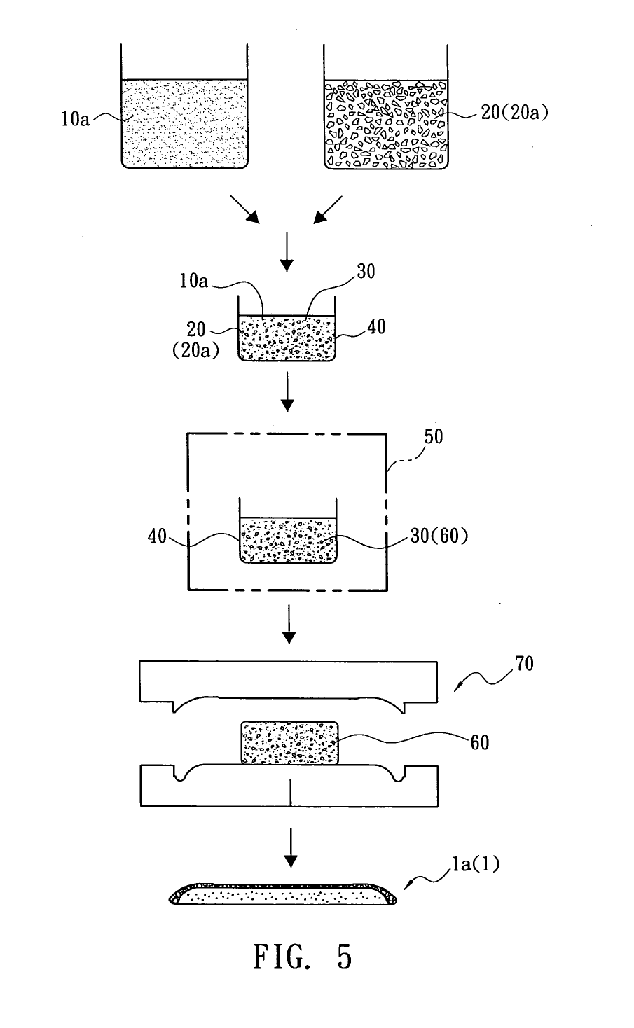

Refer to FIG. 5, a manufacturing process according to the present invention includes following steps:

step (1): providing melamine powder/particles 10a and a granular secondary material 20 that has been through hot pressing and shredding process;
step (2): mixing the melamine powder/particles 10a with the granular secondary material 20 for melamine molding in a certain ratio to compose a composite material 30 and then the composite material 30 is set into a cylindrical container 40;
step (3): putting the container 40 with the composite material 30 into a heater 50 for preheating so as to make powder/particles of the composite material 30 melt into a soft green compact 60;
step (4): mounting the soft green compact 60 into a mold 70 for utensil of the hot pressing machine for being hot pressed;
step (5): taking the molded melamine utensil 1a from the mold 60, cooling, trimming (removing flash on edges) to form a finished melamine utensil 1.

The step (3), step (4) & step (5) are similar to some steps on manufacturing process of conventional melamine utensil. Yet the manufacturing process according to the present invention increases a pre paring process—step (2). The main purpose of this step is to make the granular secondary material 20 uniformly distributed among the melamine powder/particles 10a while mixing the granular secondary material 20 with the melamine powder/particles 10a to form the composite material 30. Thus the granular secondary material 20 will not center in certain areas and the melamine powder/particles 10a can combine with molecules of the granular secondary material 20 of melamine firmly during the hot pressing process. Therefore, the granular secondary material 20 will not have peeling or cracks.

The preparing process of step (2) includes different ways such as mixing or surface paving. Take certain amount of melamine powder/particles 10a and the granular secondary material 20 and then mix them well by a blender. Pour the mixture into a cylindrical container 40 for running the step (3). The surface paving method includes two types (not shown in FIG. 5). The first type is to fill certain amount of the melamine powder/particles 10a into the container 40 and then pave the granular secondary material 20 over surface of the melamine powder/particles 10a. Then take the step (3). The other way is to pave certain amount of the granular secondary material 20 on bottom of the container 40 and then pour certain the melamine powder/particles 10a into the container 40, over the granular secondary material 20. Next run the step (3). In above paving ways, it is not necessary to pave the granular secondary material 20 all over the melamine powder/particles 10a or the bottom of the container 40. The granular secondary material 20 can be partially paved so as to make the granular secondary material 20 only show on certain area of the melamine utensil 1. Therefore, the variety of the figures formed by the granular secondary material 20 on the melamine utensil 1 is increased.

Moreover, in step (4), the mold 70 for hot pressing must be made from high hardness materials such as stainless steel with high hardness to prevent possible damages caused by hard secondary material of melamine 20.

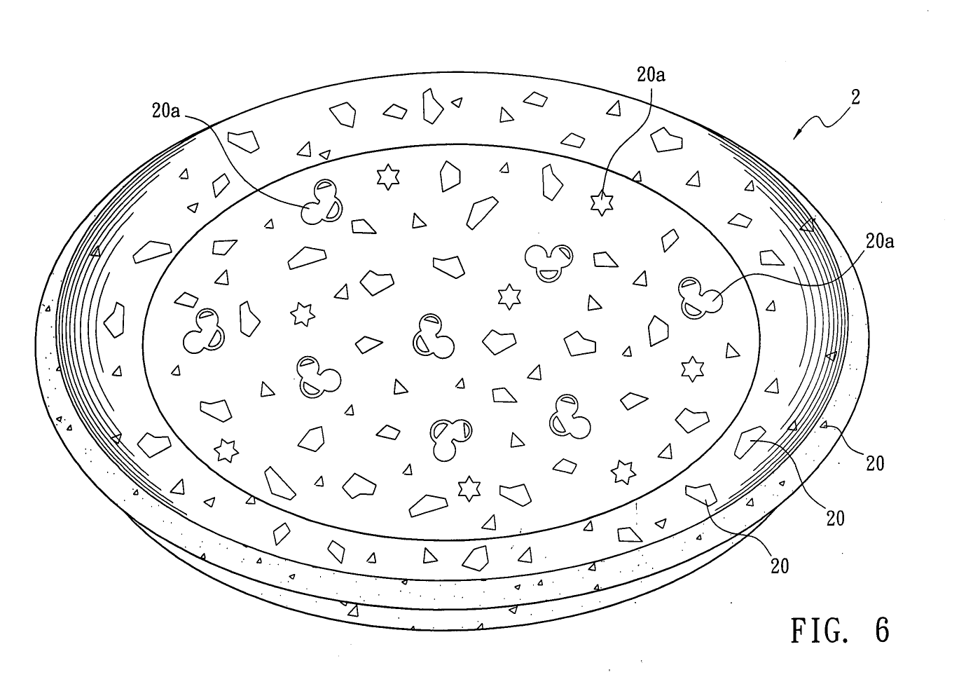

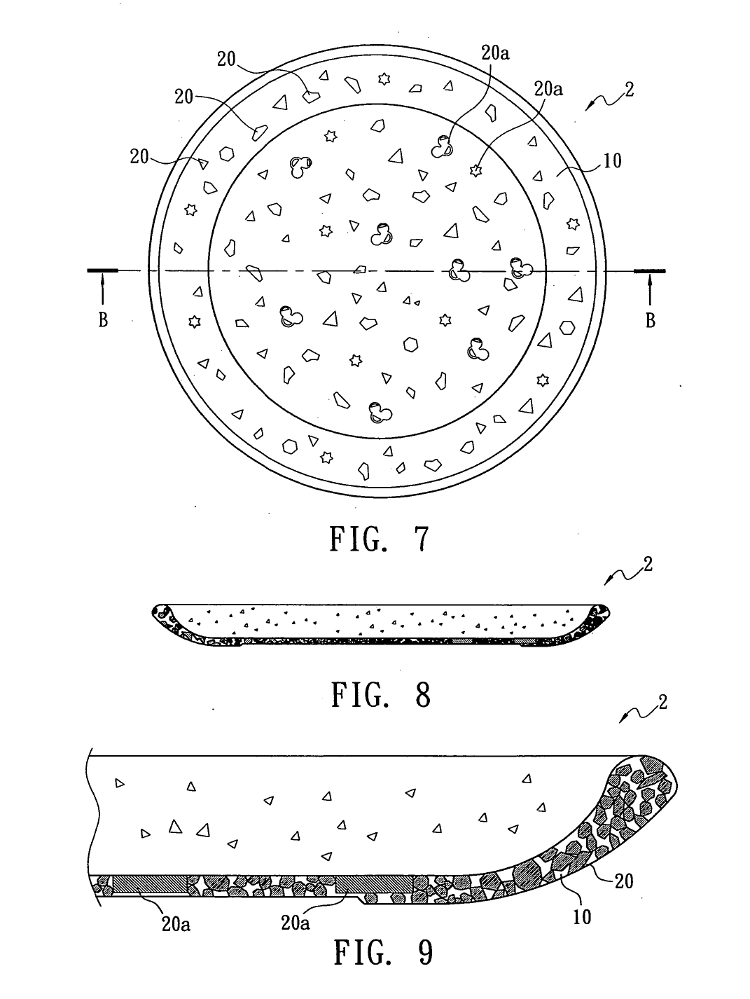

Refer from FIG. 6 to FIG. 9, the structure and manufacturing process of the melamine utensil 2 are similar to those of the above melamine utensil 1 while the difference between them is in that the melamine utensil 2 uses fragmentary secondary material 20a instead of the granular secondary material 20, as shown in figures. The fragmentary secondary material 20a is made by hot pressing the melamine powder/particles 10a into small fragments with certain thickness and various shapes such as star polygons, crescent moons, or a famous trademark such as Mickey mouse. When the fragmentary secondary material 20a is through the hot pressing process again with the melamine powder/particles 10a, the fragments will not melt. Thus the shapes and colors of the fragmentary secondary material 20a appear on outer surface of the melamine utensil 2 when the melamine powder/particles 10a is heated to form a primary material 10. The variety of the melamine utensil is increased.

When size of the fragmentary secondary material 20a is larger than thickness of the molded utensil 2, the fragmentary secondary material 20a is preferably to be filled by surface paving in the preparing process of the step (2) so as to avoid breakage of the fragmentary secondary material 20a. That means pave the fragmentary secondary material 20a over the melamine powder/particles 10a already mounted inside the container 40, or firstly the fragmentary secondary material 20a is paved on bottom of the container 40 and then fill in the melamine powder/particles 10a.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A melamine utensil made by a hot pressing process comprising a primary material of melamine and a plurality of secondary material of melamine;
the primary material of melamine is formed by the hot pressing process of melamine powder/particles and the primary material of melamine attaches to as well as connect with the secondary material of melamine also by the hot pressing process;
the secondary material of melamine is melamine material already being molded and hot-pressed; shape and color of the secondary material is shown on appearance of the melamine utensil by the hot pressing process.

2. The device as claimed in claim 1, wherein the secondary material of melamine are granules with different shapes and different sizes made from hot-pressed melamine material through a shredding process.

3. The device as claimed in claim 1, wherein granules of the secondary material of melamine are with various colors.

4. The device as claimed in claim 2, wherein the granules of the secondary material of melamine are with various colors.

5. The device as claimed in claim 1, wherein the secondary material of melamine is stylish small fragment made from hot-pressed melamine material.

6. The device as claimed in claim 1, wherein small fragments of the secondary material of melamine have various colors.

7. The device as claimed in claim 5, wherein the small fragments of the secondary material of melamine have various colors.

8. A manufacturing method of melamine utensils comprising the steps of:
providing melamine powder/particles and a plurality of secondary material of melamine while the secondary material of melamine is made from melamine material already being hot pressed;
mixing the melamine powder/particles with the secondary material of melamine in a certain ratio to compose a certain amount of composite material and then the composite material is put into a container;
putting the container with the composite material into a heater for preheating so as to make the composite material melt into a soft green compact;
mounting the soft green compact into a mold for utensil for being hot pressed;
releasing the molded melamine utensil from the mold and then cooling, trimming the molded melamine utensil to form a finished melamine utensil.

9. The method as claimed in claim 8, wherein the secondary material of melamine are granules with different shapes and different sizes made from hot-pressed melamine material through a shredding process.

10. The method as claimed in claim 8, wherein the secondary material of melamine includes stylish small fragments made from hot-pressed melamine material.

11. The method as claimed in claim 8, wherein the composite material comprising the melamine powder/particles ranging from 40 to 80 percent and the secondary material of melamine from 20 to 60 percent.

12. The method as claimed in claim 8, wherein the melamine powder/particles and the secondary material of melamine are mixed uniformly by stirring while preparing the composite material and then the composite material is put into the container.

13. The method as claimed in claim 8, wherein while mixing the melamine powder/particles and the secondary material of melamine into the composite material, firstly put the melamine powder/particles into the container and then pave the secondary material of melamine over the melamine powder/particles in the container.

14. The method as claimed in claim 8, wherein while mixing the melamine powder/particles and the secondary material of melamine into the composite material, firstly pave a plurality of secondary material of melamine on bottom of the container and the put the melamine powder/particles over the secondary material of melamine in the container.
